(19) United States
(12) Patent Application Publication
(10) Pub. No.: US 2006/0187336 A1
(43) Pub. Date: Aug. 24, 2006

(54) System, method and computer program product for distributed moderation of theatrical productions

(75) Inventor: Louis B. Rosenberg, Arroyo Grande, CA (US)

Correspondence Address: LAW OFFICE OF PHILIP A STEINER, 4251 SOUTH HIGUERA STREET, SUITE 800-Z, SAN LUIS OBISPO, CA, 93401, US

(73) Assignee: Outland Research, L.L.C., Pismo Beach, CA (US)

(21) Appl. No.: 11/323,420

(22) Filed: Dec. 31, 2005

Related U.S. Application Data
(60) Provisional application No. 60/654,251, filed on Feb. 18, 2005.

(51) Int. Cl. H04N 5/222

(52) U.S. Cl. 348/370

(57) ABSTRACT

System, method and computer program product for a distributed computer-moderated theatrical production. The invention relates to computer moderated shared spaces in which multiple users participate in a shared theatrical experience, the shared theatrical experience including a plurality of users performing lines from a theatrical script, the theatrical lines being sent and displayed to the users under computer control. This invention includes both virtual and physical embodiments. In virtual embodiments users perform remotely through computer generated avatars in a shared virtual space. In physical embodiments users perform together in a real physical space while wearing the portable theatrical units. In both embodiments, the users receive theatrical information from one or more moderating computers, the theatrical information including scripted dialog and/or stage directions that are distributed to users under intelligent computer control.

### CROSS-REFERENCE TO RELATED APPLICATIONS

This application is a non-provisional application claiming benefit and priority under 35 U.S.C. §119(e) from applicant's co-pending U.S. provisional application Ser. No. 60/654,251 filed on Feb. 18, 2005 to the instant inventor; the aforementioned provisional application is hereby incorporated by reference in its entirety as if fully set forth herein.

### FEDERALLY SPONSORED RESEARCH AND DEVELOPMENT

Not Applicable

### REFERENCE TO A MICROFICHE APPENDIX

Not Applicable

### FIELD OF INVENTION

The present invention relates to computer-moderated theatrical experiences shared among one or more users. More specifically, this invention relates to computer moderated shared spaces in which one or more users participate in a shared theatrical experience, the shared theatrical experience including at least one user performing lines from a theatrical script, the theatrical lines being sent to the user(s) either in a physically or virtually shared space under computer control.

### BACKGROUND

Computer moderated theatrical productions of live or users is desirous in situations where the users have not fully learned their lines, are attempting to refine a performance, to enhance a theatrical script, and other theatrical uses. The relevant art utilizes direct verbal feedback from the production directors or otherwise communicates by simple analog radio to control the theatrical production. However, direct verbal feedback and simple analog radios do not work in virtually shared space arrangements. Therefore, computer moderation of both real and virtual theatrical performance is desirable in the relevant art.

In addition, the potential benefits of such computer moderations are particularly desirous to support theatrical performances by hobbyist who wish to quickly and easily engage in shared theatrical experiences with friends by selecting a theatrical script and acting out the performance together with limited or no prior rehearsal.

### SUMMARY

The invention as described herein addresses the need in the relevant art and provides in various inventive embodiments an intelligent theatrical moderating system, method and computer program product. The systemic embodiment of the invention comprises a first computer in processing communications with at least one recipient device. The first computer includes a theatrical moderating program operatively loaded into its main memory. The theatrical moderating program includes instructions executable by a processor associated with the first computer to; retrieve at least a portion of a theatrical script from a secondary memory operatively coupled to at least the first computer; determine at least one recipient device of the retrieved portion of the theatrical script; and distribute the retrieved portion of the theatrical script to at least one recipient device in a predetermined sequence. The theatrical script includes a plurality of theatrical lines, in which each of the theatrical lines are associated with at least one theatrical character;

The retrieved portion of the theatrical script may include at least a dialog, but may also include a movement, a gesture, a gesticulation, a facial expression, a direction, and a cue to be performed by the user. In related systematic embodiments, the retrieved portion of the theatrical script may undergo a text to speech conversion before being sent to the user. Alternately, words spoken by the user may undergo speech to text conversion which is performed after the retrieved portion of the theatrical script is sent to the user.

Various systematic embodiments of the invention further provides the theatrical moderating program instructions executable by the processor to continue the predetermined sequence in dependence on receipt of a signal sent by at least one recipient device and performance of the text to speech conversion or speech to text conversions.

Additional related embodiments of the invention provides the theatrical moderating program instructions executable by the processor to control special effects, lighting, sound, props, and background scenery.

Various systematic embodiments of the aforementioned recipient device includes at least a second computer in processing communications with the first computer or at least one user existing in a physically shared space and having associated therewith a portable theatrical unit.

In another related systematic embodiment of the invention, the first computer and at least the second computer share a virtually shared space in which at least one avatar exists; the movements of the avatar being controlled by the user from the second computer system. Alternately the movements of the avatar may be controlled by the first computer when the user has not been assigned to a particular part.

In various related systematic embodiments of the invention, the aforementioned theatrical unit includes a user interface functional to communicate the distributed theatrical script to at least one user associated with the portable theatrical unit. The portable theatrical unit may be one of, a personal digital assistant, a cellular telephone, a wireless headset, a wearable display, a wearable computer, a theatrical moderating computer and any combination thereof. The aforementioned user interface may include a wearable display, an earphone, a microphone, a switch, a button, a knob and any combination thereof.

The plurality of theatrical lines are selected from the theatrical script may be based upon a preference between at least one user and at least one theatrical character.

Additional related systematic embodiments of the portable theatrical unit provides a wireless communications link between at least the first computer and the portable theatrical unit; a VOX circuit functional to send the signal to at least the first computer when the user has at least stopped speaking; a motion sensor circuit functional to send the signal to the first computer when the user has at least stopped moving and a peripheral state sensing circuit functional to send the signal to at least the first computer when at least one user has interacted with a peripheral device operatively coupled to the peripheral state sensing circuit.

In a first methodic embodiment of the invention an intelligent method of theatrical moderating is provided. The first methodic embodiment of the invention comprises providing a theatrical moderating program operatively loadable into a main memory of a first computer and executable by a processor associated therewith; providing in a secondary memory associated with at least the first computer a retrievably stored theatrical script; providing the theatrical moderating program instructions executable by the processor to retrieve at least a portion of the theatrical script; providing the theatrical moderating program instructions executable by the processor to determine at least one recipient device for the retrieved portion of the theatrical script; and, providing the theatrical moderating program instructions executable by the processor to distribute the retrieved portion of the theatrical script to at least one recipient device in a predetermined sequence.

The theatrical script may include a plurality of theatrical lines, each of the theatrical lines being associated with at least one theatrical character; and, where at least one recipient device may be associated with at least one theatrical character. In a related methodic embodiment, the invention includes providing the theatrical moderating program with instructions executable by the processor to continue the predetermined sequence in dependence on receipt of a signal sent from at least one recipient device. In another related methodic embodiment, the invention includes providing the theatrical moderating program with instructions executable by the processor to perform at least one of; text to speech conversion and speech to text conversion.

In a yet another related methodic embodiment, the invention includes providing the theatrical moderating program with instructions executable by the processor to control a distributed virtually shared space.

In a second methodic embodiment of the invention, a computer moderated method of coordinating a plurality of users engaged in a shared theatrical experience is provided. The second methodic embodiment of the invention comprises providing an intelligent display device to each of the plurality of users; each of the intelligent display devices including a processor, a memory coupled to the processor, and a display coupled to the processor to the processor; providing a theatrical script loadable into the memory of each of the intelligent display devices, wherein the theatrical script includes a plurality of theatrical lines, each of the plurality of theatrical lines having an association with at least one of a plurality of available theatrical characters; providing a theatrical moderating program loadable into the memory of each of the intelligent display devices including instructions executable by each of the processors to; implement an assignment of the intelligent display device with the at least one of the plurality of available theatrical characters; access from the memory, a theatrical line of the plurality of theatrical lines having the association; and, display at least a portion of the accessed theatrical line to a user of the plurality of users in at least partial dependence upon a correlation between the association and the assignment.

In related methodic embodiments of the invention, the cue is provided to the user in at least partial dependence on a predetermined sequence defined by the theatrical script; the cue is provided to the user in at least partial dependence on a timing signal sent from at least a second intelligent display device; and the cue is displayed in a visual text format representing at least a portion of the plurality of theatrical lines, where the displayed includes graphically accentuating the visual text format.

In other related method embodiments of the invention, the display of the accessed theatrical line is provided to the user in at least partial dependence on a predetermined sequence of theatrical lines defined by the theatrical script; the display of the accessed theatrical line is provided to the user in at least partial dependence on a signal sent from at least a second intelligent display device; the display of the accessed theatrical line is provided in a visual text format; the display of the accessed theatrical line is provided in an audio format.

In further related methodic embodiments of the invention, the intelligent display device is embodied in a container dimensioned to be worn or carried by the user; the intelligent display device is a computer programmed to display a virtual shared space in which at least a plurality of avatars exist, each of the avatars representing a theatrical character of the shared theatrical experience; at least one theatrical character is determinable by an input provided by the user of the intelligent display device; and each of the intelligent display devices is associated with a different theatrical character of the shared theatrical experience.

In final related methodic embodiments of the invention, the intelligent display device is a computer programmed to display a virtual shared space in which at least one avatar exists, the avatar representing the at least one theatrical character, where the at least one theatrical character being associated with the user and determined by an input provided by the user and processed by the intelligent display device.

In a computer program product embodiment of the invention, a computer program product embodied in a tangible form includes instructions executable by a processor to retrieve at least a portion of a theatrical script from a secondary memory operatively coupled to at least the first computer; determine at least one recipient device of the retrieved portion of the theatrical script; and distribute the retrieved portion of the theatrical script to at least one recipient device in a predetermined sequence. The tangible form comprises magnetic media, optical media or logical media.

In a related computer program product embodiment, the invention includes instructions executable by the processor to continue the predetermined sequence in dependence on receipt of a signal sent by at least one recipient device. In another related computer program product embodiment, the invention includes instructions executable by the processor to perform at least one of; text to speech conversion and speech to text conversion. In a final related computer program product embodiment, the invention includes instructions executable by the processor to control a distributed virtually shared space. In a related computer program product embodiment of the invention, at least one recipient device is associated with at least one theatrical character. In another related computer program product embodiment of the invention the instructions executable by the processor are provided a cue to issue to a user; where the cue is one of a visual and aural cue. The cue may be provided at one of a predetermined time and a predetermined event.

### BRIEF DESCRIPTION OF DRAWINGS

The features and advantages of the invention will become apparent from the following detailed description when considered in conjunction with the accompanying drawings. Where possible, the same reference numerals and characters are used to denote like features, elements, components or portions of the invention. Optional components or feature are generally shown in dashed lines. It is intended that changes and modifications can be made to the described embodiment without departing from the true scope and spirit of the subject invention as defined by the claims.

FIG. 1 depicts a generalized block diagram of a theatrical moderating computer.

FIG. 1A depicts a generalized block diagram of a theatrical unit.

FIG. 1B depicts an implementation of an embodiment of the invention.

FIG. 1C depicts an exemplary programmatic representation of a theatrical script implemented by an embodiment of the invention.

FIG. 2 depicts a physically shared space embodiment of the invention.

FIG. 2A depicts a virtually shared space embodiment of the invention.

FIG. 3 depicts a process flow chart of the various embodiments of the invention.

### DETAILED DESCRIPTION

The invention provides a system, method and computer program product for coordinating one or more of users in computer moderated theatrical performances conducted in physically shared spaces and virtually shared spaces. Various embodiments of the present invention enables theatrical lines to be accessed from a stored file of theatrical script data and be intelligently distributed and presented to one ore more users to facilitate their live collaborative performance of a theatrical performance in a shared physical space. Alternately the present invention enables theatrical lines to be accessed from a stored file of script data and be intelligently distributed and presented to a plurality of users to facilitate their remote collaborative performance of a theatrical performance in a shared virtual space Where necessary, computer programs and algorithms are envisioned to be programmed in a high level language object oriented language, for example Java™ C++, C#, or Visual Basic™.

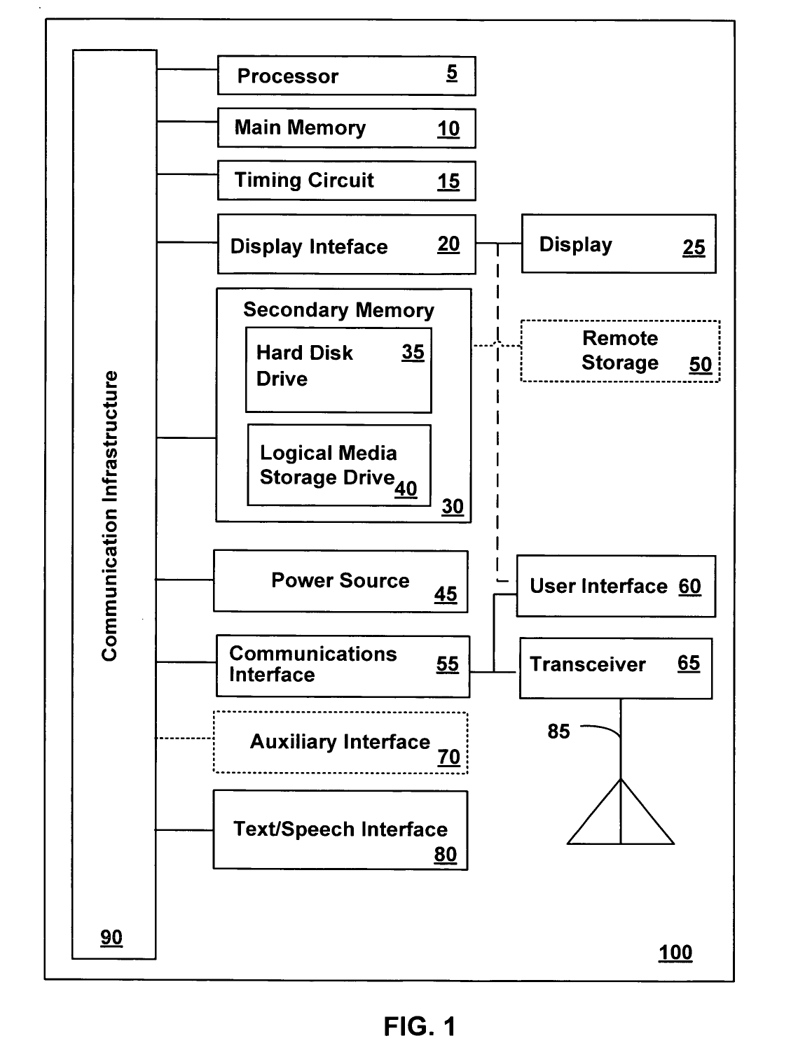

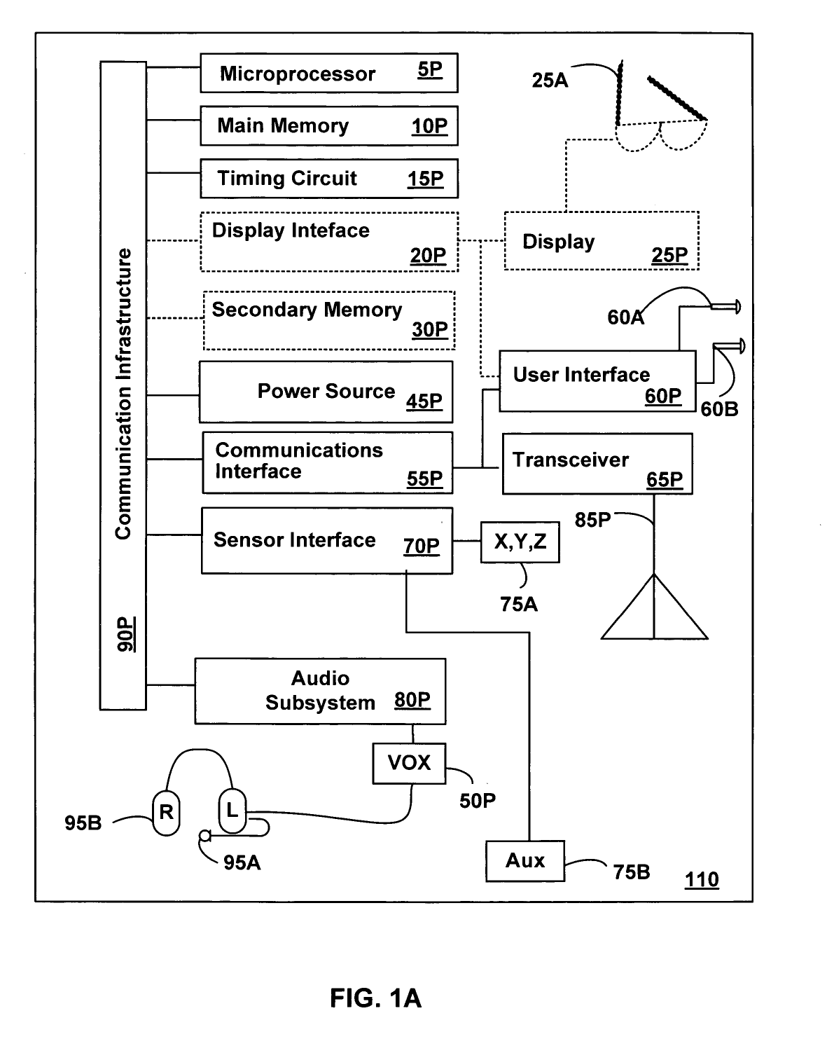

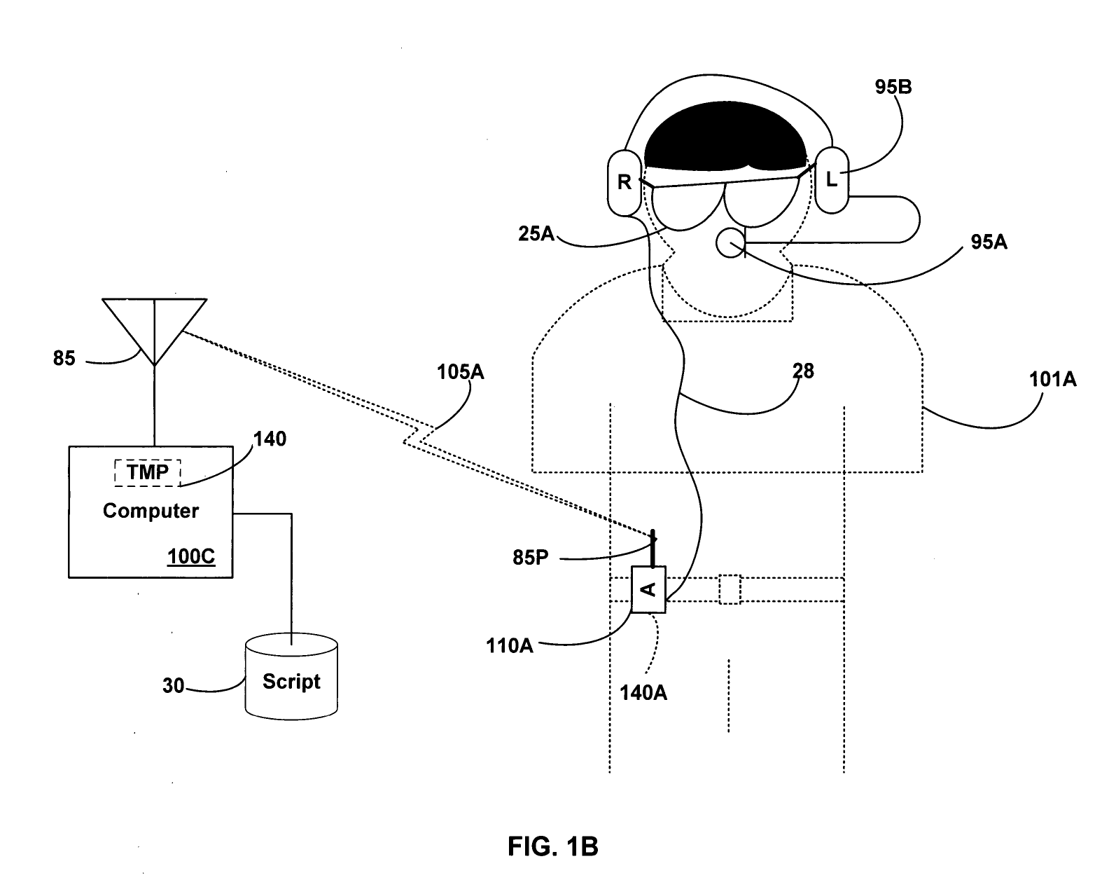

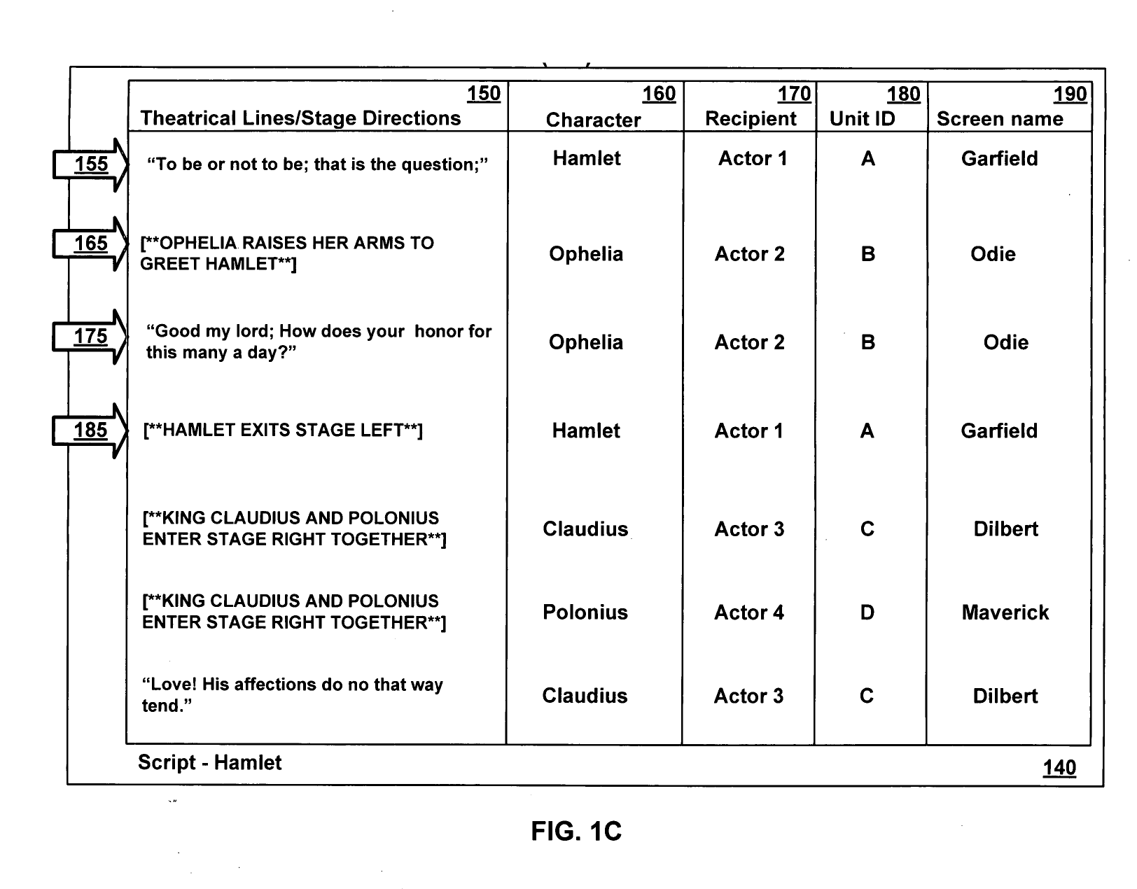

Referring to FIG. 1, a generalized block diagram of a theatrical moderating computer 100 is depicted. The theatrical moderating computer 100 includes a communications infrastructure 90 used to transfer data, memory addresses where data items are to be found and control signals among the various components and subsystems associated with the theatrical moderating computer 100.

A processor 5 is provided to interpret and execute logical instructions stored in the main memory 10. The main memory 10 is the primary general purpose storage area for instructions and data to be processed by the processor 5. The main memory 10 is used in its broadest sense and includes RAM, EEPROM and ROM.

A timing circuit 15 is provided to coordinate activities within the theatrical moderating computer 100 in near real time. The processor 5, main memory 10 and timing circuit 15 are directly coupled to the communications infrastructure 90.

A display interface 20 is provided to drive a display 25 associated with the theatrical moderating computer 100. The display interface 20 is electrically coupled to the communications infrastructure 90 and provides signals to the display 25 for visually outputting both graphics and alphanumeric characters. The display interface 20 may include a dedicated graphics processor and memory to support the displaying of graphics intensive media. The display 25 may be of any standard type for use with theatrical moderating computer 100.

A secondary memory subsystem 30 is provided which houses retrievable storage units such as a hard disk drive 35, a logical media storage drive 40, and an optional remote storage device 50. One skilled in the art will appreciate that the hard drive 35 may be replaced with flash memory.

The logical storage drive 40 may be a replaceable hard drive, optical media storage drive or a solid state flash RAM device. The logical media storage drive 40 may also include a flash RAM device, an EEPROM encoded with playable media, or optical storage media (CD, DVD). The remote storage unit 50 may be logical, optical or of an electromechanical (hard disk) design.

A power source 45 is provided to supply electrical power to the various components, systems and subsystems incorporated into the theatrical moderating computer 100. The power source 45 may be a standard AC to DC internal supply and/or an internal battery.

A communications interface 55 subsystem is provided which allows for standardized electrical connection of peripheral devices to the communications infrastructure 90 including, serial, parallel, USB, and Firewire™ connectivity. For example, a user interface 60 and a transceiver 65 are electrically coupled to the communications infrastructure 90 via the communications interface 55. For purposes of this specification, the term user interface 60 includes the hardware and operating software by which a user interacts with the theatrical moderating computer 100 and the means by which the theatrical moderating computer 100 conveys information to a user and may include the display 25.

The transceiver 65 facilitates the remote exchange of data and synchronizing signals between the theatrical moderating computer 100 and other devices in processing communications using an antenna 85 coupled to the transceiver 65.

The transceiver 65 in a physically shared space embodiment of the invention is envisioned to be of a radio frequency type normally associated with computer networks for example, wireless computer networks based on BlueTooth™ or the various IEEE standards 802.11x, where x denotes the various present and evolving wireless computing standards. Alternately, compatible digital cellular communications formats may be used in the invention, for example GSM, 3G and evolving cellular communications standards.

Both peer-to-peer (PPP) and client-server models are envisioned for implementation of the invention. The transceiver 65 in a virtually shared space embodiment of the invention may be accomplished using any wired or wireless network conductivity arrangement. In a third alternative embodiment, the transceiver 65 may include hybrids of computer communications standards, cellular standards and evolving satellite radio standards.

The user interface 60 employed on the theatrical moderating computer 100 may include a pointing device (not shown) such as a mouse, thumbwheel or track ball, an optional touch screen (not shown); one or more pushbuttons (not shown); one or more sliding or circular rheostat controls (not shown) and one or more switches (not shown.)

The user interface 60 provides interrupt signals to the processor 5 that may be used to interpret user interactions with the theatrical moderating computer 100 and may be used in conjunction with the display 25. One skilled in the art will appreciate that the user interface devices which are not shown are well known and understood.

An optional auxiliary interface 70 is provided which allows one or more external systems to be controlled by the theatrical moderating computer 100. For example, in the physically shared space embodiment of the invention, the theatrical moderating computer 100 may be used to control lighting, special effects, background scenery and sound parameters (volume, tones, equalization, microphone operation, stereo separation and related sound parameters.)

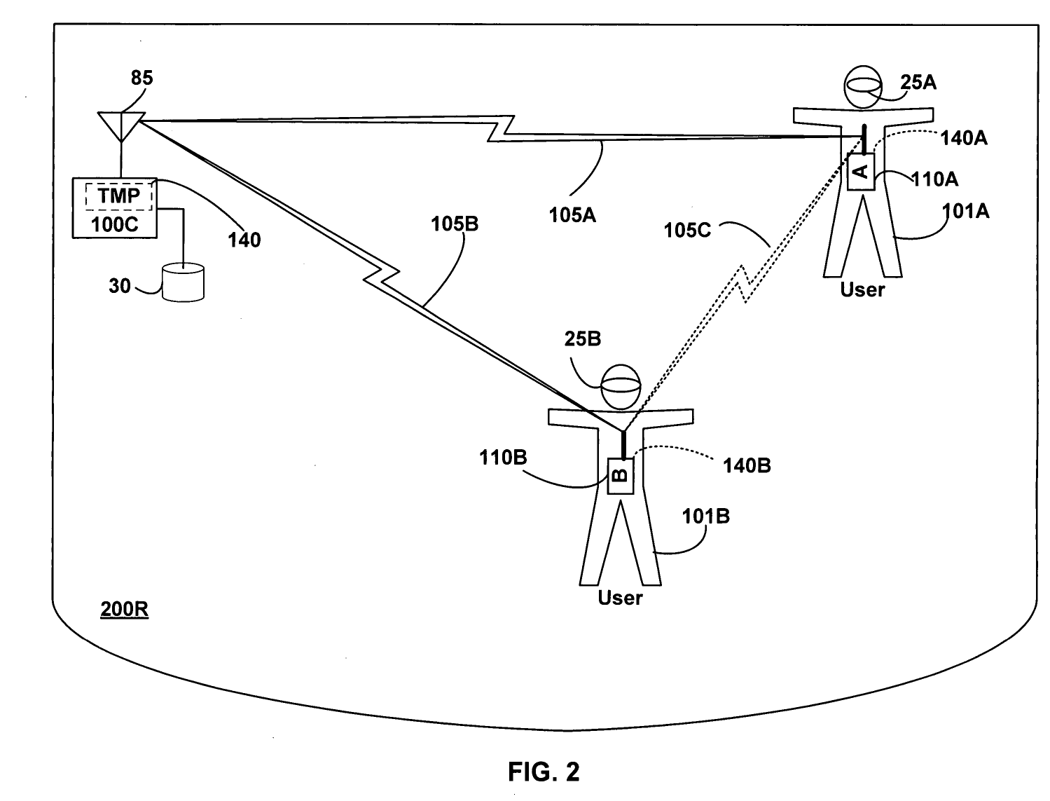

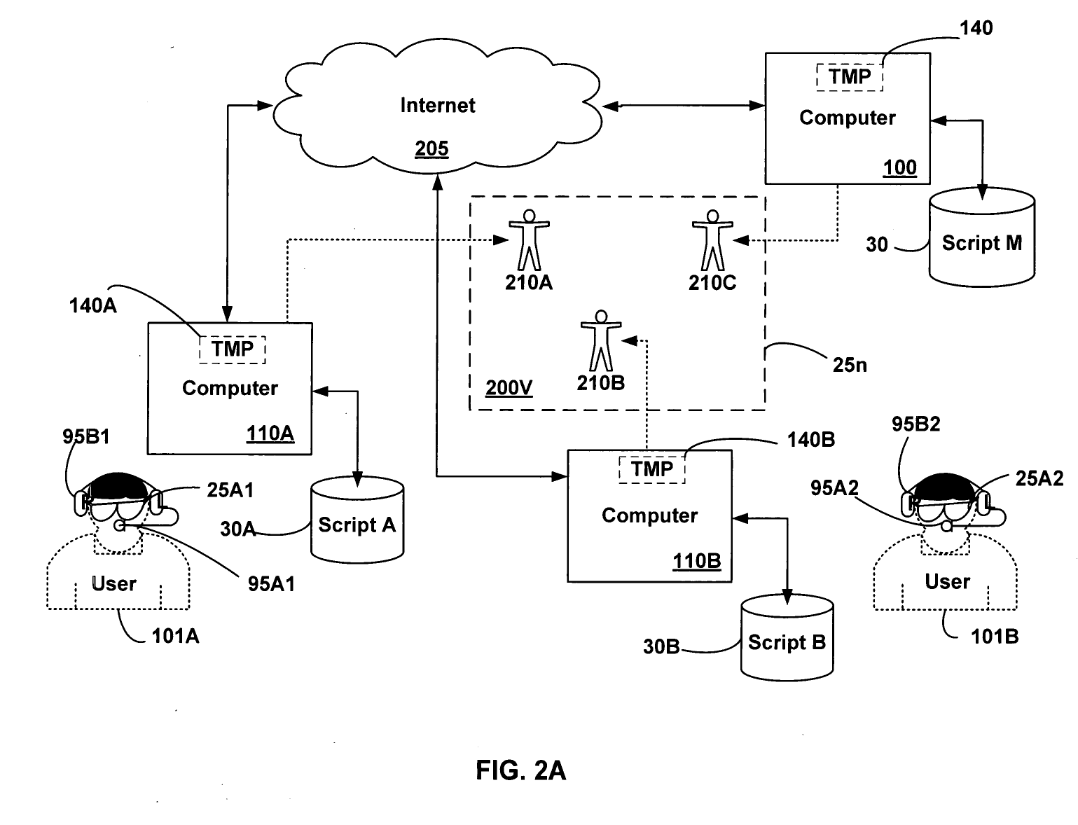

In the virtually shared space embodiment of the invention, the theatrical moderating computer 100 directly controls, the entire theatrical production in conjunction with one or more networked computers 110A, 110B (FIG. 2A) The auxiliary systems may be operatively coupled to the auxiliary interface 70 by an external jack, plug or wireless arrangement which utilizes the transceiver 65.

A text/speech processing interface 80 is provided and electrically coupled to the communications infrastructure 90. The text/speech processing interface 80 includes the necessary hardware and/or software components for operability and provides for either or both text to speech conversion of dialog data accessed from a stored theatrical script data file, or speech recognition of spoken dialog performed by one or more users of the invention. In one example, the text/speech interface 80 may be used to convert the retrieved text representing part or all of a theatrical line(s) into computer synthesized speech such that the theatrical lines may be presented audibly to one or more users of the invention as an alternative or in addition to a textual representation of the theatrical line(s). In such embodiments, an earphone may be worn by the user, enabling the user to be cued by the synthesized speech representation of the theatrical line(s) played through an earpiece, headphones, or other audio output device. This may enable the user to focus his or her visual attention freely during the performance and still receive theatrical lines and performance cues from a stored theatrical script that includes textual dialog information.

In other embodiments the stored script may include pre-recorded audible dialog information and may therefore not require the text to speech conversion step. The pre-recorded dialog information may be stored in any of the exemplary formats MP3, AVI, WAV, MPG, QT, WMA, AIFF, AU, RAM, RA, MOV, MIDI, etc.

The text/speech interface 80 may also be used to perform speech recognition upon the dialog spoken by one or more users who is performing theatrical lines within the performance. The speech recognition may be used to enable the theatrical moderating computer 100 to monitor where within a theatrical script one or more users is currently performing from. In this way, for example, the theatrical moderating computer 100 may monitor when a user finishes verbally reciting a particular theatrical line and in response may cue the user, or another user, to perform a next theatrical line in a predetermined sequence of theatrical lines. In such speech recognition embodiments of the invention, at least one microphone 95A (FIG. 1A) would be required. The microphone 95A may be coupled directly to the text/speech processing interface 80 or coupled to a portable theatrical unit 110 (FIG. 1A) worn or proximate to a user. In addition, the speech recognition functions may be. performed by the theatrical moderating computer 100 or by one or more portable theatrical units 110. As referred to in this specification, “media” refers to video, audio, streaming and any combination thereof.

In addition, the text/speech processing interface 80 is envisioned to optionally include features such as graphic equalization, volume, balance, fading, base and treble controls, surround sound emulation, and noise reduction. One skilled in the art will appreciate that the above cited list of file formats is not intended to be all inclusive.

The theatrical moderating computer 100 includes an operating system, the necessary hardware and software drivers necessary to fully utilize the devices coupled to the communications infrastructure 90, media playback and recording applications and at least one theatrical moderating program 140 (FIG. 1B) operatively loaded into the main memory 10. The at least one theatrical moderating program 140 (FIG. 1B) is programmed to retrieve at least a portion of a theatrical script from a datastore or file coupled to the secondary memory 30. The theatrical script includes a plurality of theatrical lines, each of the theatrical lines being associated with one or more theatrical characters.

The theatrical moderating program 140 determines based upon the one or more theatrical characters associated with a plurality of theatrical lines, which recipient device(s), usually one or more portable theatrical units 110, each of the theatrical lines will be distributed to and/or presented by. This determination may be performed using a unique identifier which may be encoded in the theatrical script or assigned later, the unique identifier indicating which theatrical lines are associated with which theatrical characters within the theatrical script. In an embodiment of the invention, the theatrical moderating program 140 may wait for a signal, a specific line to be spoken, a button press from a user, a certain motion to be performed, or some other interaction with an external peripheral device before continuing the theatrical script distribution and/or display.

Depending on the embodiment of the invention, the theatrical script may include textual lines of dialog, stage directions, facial expressions, gesticulations, gestures, recipient movements and other verbal and non verbal forms of communication.

References to the at least one theatrical moderating program 140 (FIG. 1B) may be made in both singular and plural form. No limitation is intended by varying the grammatical usage as one skilled in the art will appreciate that multiple programs, objects, subprograms routines, algorithms, applets, contexts, etc. may be developed programmatically to implement the various embodiments of the invention.

In FIG. 1A, a general block diagram of portable theatrical unit 110 is depicted. The portable theatrical unit 110 may be worn or disposed in proximity to a user or integrated into a personal digital assistant, a cellular telephone, a wireless headset, a wearable display, a wearable computer, a theatrical moderating computer and any combination thereof.

The portable theatrical unit 110 includes a communications infrastructure 90P used to transfer data, memory addresses where data items are to be found and control signals among the various components and subsystems associated with the portable theatrical unit 110.

A microprocessor 5P is provided to interpret and execute logical instructions stored in the main memory 10P. The main memory 10P is the primary general purpose storage area for instructions and data to be processed by the microprocessor 5P. The main memory 10 is used in its broadest sense and includes RAM, EEPROM and ROM.

A timing circuit 15P is provided to coordinate activities within the portable theatrical unit 110 in near real time. The microprocessor 5P, main memory 10P and timing circuit 15P are directly coupled to the communications infrastructure 90P.

An optional display interface 20P is provided to drive an optional display 25P associated with the portable theatrical unit 110. The display interface 20P, when present, may be electrically coupled to the communications infrastructure 90P and provides signals to the optional display 25P for visually outputting both graphics and alphanumeric characters. The optional display interface 20P may include a dedicated graphics processor and memory to support the displaying of graphics intensive media. The optional display 25P may be of a liquid crystal display (LCD) incorporated into the case housing the. portable theatrical unit 110 or may be a peripheral device such as a wearable display incorporated into a pair of eyeglasses 25A.

A secondary memory subsystem 30P is provided which maintains the users portion of the theatrical script sent from the theatrical moderating computer 100. In alternate embodiments of the invention, much or all of the theatrical script may be stored within the secondary memory 30P and the theatrical moderating program 140A executed locally by the processor 5P of the portable theatrical unit 110. In this localized embodiment of the invention, the portable theatrical unit 110 selectively displays 25P the theatrical lines to the user based upon which character the theatrical lines are associated with. For example, much or all of a theatrical script of Shakespeare's Hamlet may be stored within the secondary memory 30P of the portable theatrical unit 110; and if the portable theatrical unit 110 is configured to support the role of Ophelia, the portable theatrical unit 110 only displays 25P the theatrical lines associated with the character Ophelia to the user.

A power source 45P is provided to supply electrical power to the various components, systems and subsystems incorporated into the portable theatrical unit 110. The power source 45P is an internal DC supply in the form of an internal battery.

A communications interface 55P subsystem allows for the electrical coupling of a user interface 60P and a wireless transceiver 65P to the communications infrastructure 90P via the communications interface 55P. The user interface 60P may be as simple as one or more pushbuttons, knobs, 60A, 60B or other similar devices. In an embodiment of the invention, the control of timing of distributing the theatrical lines may be accomplished manually by use of the one or more pushbuttons 60A, 60B.

Each time the user presses the one or more pushbuttons 60A, 60B, a signal is transmitted to the theatrical moderating program 140 (FIG. 2) indicating that the user is ready for another set of lines. Upon receipt of this signal, the theatrical moderating program 140 transmits a new set of lines to the user.

In another embodiment of the invention, the display 25P of a new set of lines to a first user may be dependent upon an action or dialog provided by a second user. For example, one user may press a button or cease speaking or otherwise indicate that he or she has finished reciting a theatrical line and the user of another portable theatrical unit whose character comes next in the script may be cued by his or her portable theatrical unit. The transceiver 65P and antenna 85P facilitates the remote exchange of data and synchronizing signals between the portable theatrical unit 110 and the theatrical moderating computer 100.

As stated previously, the transceiver 65P may be a wireless type for use in the physically shared space embodiment of the invention or may be accomplished using any wired or wireless network conductivity arrangement and hybrids thereof in the virtually shared space embodiments of the invention.

An optional sensor interface 70P is provided which allows for the connection of a motion sensor 75A and/or an external peripheral device 75B to the portable theatrical unit 110. For example, the motion sensor 75A may be used in the physically shared space embodiment to detect the movement of a user.

The external peripheral device could for example be a model of a gun, which when the trigger is pulled provides a signal to the theatrical moderating computer 100 via the portable theatrical unit 110 to provide a gunshot sound effect. In a virtually shared space embodiment of the invention, the portable theatrical unit 110 controls via the theatrical moderating computer 100, one or more avatars assigned to the user.

Lastly, an audio subsystem 80P is provided and electrically coupled to the communications infrastructure 90P. In an embodiment of the invention, the audio subsystem 80 provides for the aural output of the theatrical script sent from the theatrical moderating computer 100. The aural output may be provided directly from the theatrical moderating computer 100 or sent as an multi media formatted file (e.g., MPG) which is played back by the portable theatrical unit 110.

The user listening to the aural output either follows the received “stage” directions or repeats the theatrical lines received. Several various embodiments of the invention may be provided. A voice operated switch (VOX) 50P unit may optionally be attached to or incorporated into the Audio Subsystem 80P to turn off a microphone 95A after the user has completed his lines. In addition, the VOX 50P may also be used to signal the theatrical moderating computer 100 when the user has completed his lines.

In a simplest embodiment of the invention, a wireless earphone 95B is disposed on a user who receives the aural output distributed from the theatrical moderating computer 100. In this embodiment of the invention, the theatrical moderating computer sequences the theatrical lines to be distributed by monitoring an onstage microphone (not shown). The transceivers 65, 65P may communicate over a Bluetooth™ network which automatically assigns unique identifiers to each Bluetooth™ device. A simple menu on the theatrical moderating computer is used to designate which Bluetooth™ device is associated with each user. In another simple embodiment of the invention, a wireless headset (microphone 95A and earphone 95B) is provided and worn by each user. This embodiment allows for more accurate determination of when a user has finished his lines and also allows for the recording of each user's part.

In a third embodiment of the invention, the headset 95A, 95B and a wearable visual display 25A are worn by one or more users. The text of the theatrical script may be sent to the appropriate user and read directly off the screen. Alternately, or in addition thereto, the text of the theatrical script may include stage instructions, required facial expressions required gesticulations or gestures or repositioning information. In another related embodiment, the text of the theatrical script is highlighted or otherwise visually identified so that a user knows when to speak his or her lines or follow the received stage directions.

In various embodiments of the invention, each portable theatrical unit 110 includes an operating system or equivalent embedded device, the necessary hardware and software drivers to fully utilize the devices coupled to its communications infrastructure 90P, and a counterpart theatrical moderating program 140A operatively loaded into its main memory lop.

Referring to FIG. 1B, an exemplary embodiment of the invention is shown where a user 101A performing in a physically shared space is equipped with a microphone 95A, earphones 95B and a wearable display 25A. The microphone 95A, earphones 95B and wearable display 25A are coupled by a cable 28 to the portable theatrical unit 110A. One skilled in the art will appreciate that a wireless link may exist between the microphone 95A, headphones 95B and wearable display 25A and the portable theatrical unit 111A. Alternately, the microphone 95A and earphones 95B may be integrated into the wearable display 25A.

Using an antenna 85P coupled to the portable theatrical unit 110A, the portable theatrical unit 110A is in processing communications over a wireless link 105A with the theatrical moderating computer 100. In this embodiment of the invention, the theatrical moderating computer 100 retrieves from a datastore 30 portions of the theatrical script applicable to the user 101A and either transmits using its antenna 85 the entire script for this user 101A or provides the theatrical script line by line visually, aurally or by both methods.

To accomplish the theatrical moderating, the theatrical moderating computer 100 includes the theatrical moderating program 140 operatively loaded into its main memory. Likewise, in various embodiments of the invention, the portable theatrical unit 110A includes a counterpart theatrical moderating program 140A (not shown.)

In FIG. 1C an example of how the theatrical moderating program 140 moderates a theatrical script is depicted. An excerpt of William Shakespeare's Hamlet is used for exemplary purposes. In an embodiment of the invention, the theatrical moderating computer 100 reads and/or sends a theatrical line 155 of the theatrical script 30 associated with a particular character 160 to the appropriate recipient device 170 based on a unique identifier 180 associated with each portable theatrical unit 110 involved in the theatrical production and/or based upon the theatrical character 160 that is associated with the theatrical line and a theatrical character associated with the portable theatrical unit 110. In a virtually shared space embodiment, the theatrical line 155 may be sent to a username, screen name, computer ID, or computer address that is associated with the particular character and/or particular ID that is associated with a line of the script, username or screen name 190. In a virtually shared space embodiment, the theatrical line 155 may be sent to a username or screen name 190.

The theatrical line 155 may be distributed to the recipient devices 170 either as text or aurally depending on the embodiment of the invention. Likewise the theatrical script 30 or individual theatrical lines 155 may be stored in a multimedia format, for example, mpg format which is sent either aurally to the appropriate recipient device 170 or as a multimedia file for playback by the portable theatrical unit 110. The theatrical script 30 may include stage directions, for example an action to be performed by a user 165, “OPHELIA RAISES HER ARMS TO GREET HAMLET,” or directions to a particular user depart the current scene 185, [HAMLET EXITS STAGE LEFT.] A theatrical line may be associated with more than one character in the production. In various embodiments, a theatrical line, for example a stage direction, may be associated with all the theatrical characters in the production.

With respect to a required stage direction, the motion sensor 75A associated with the portable theatrical unit 110 and theatrical moderating software 140A may be configured to detect the motion by the user and in response, cue the user to speak his or her next line 175 and/or perform the directed action 185. The term. “theatrical line(s)” is intended to include spoken, non-verbal communications and stage directions for the user(s) to follow. The theatrical lines may be distributed with a cue which provides information to the user(s) as to when the theatrical line or action is to be presented. For example, the theatrical lines, stage direction or gesture may be provided a minute in advance and subsequently highlighted or a tone signal provided by the theatrical moderating computer 100 when it is time for the theatrical line's presentation.

FIG. 2 depicts the physically shared space embodiment of the invention. This embodiment of the invention is directed toward performance areas 200R and/or real theatrical presentations in which the users 101A, 101B are physically present together. In this exemplary embodiment, the users 101A, 101B are each equipped with portable theatrical units 110A, 110B running the counterpart theatrical moderating program 140A, 140B (not shown.)

The portable theatrical units 110A, 110B are in processing communications with the theatrical moderating computer 100 in either a client-server arrangement or as independently operating computers, using the theatrical moderating computer 100 as simply a remote theatrical script storage location. The theatrical moderating computer 100 includes the operatively loaded theatrical moderating program 140 and retrieves the applicable portions of the theatrical scripts for the users 101A, 101B associated with the portable theatrical units 110A, 110B from the datastore 30.

The portions of the theatrical script applicable to each user 101A, 101B is determined by the unique identifier assigned to each portable theatrical unit A 110A or B 110B. In this embodiment of the invention, the retrieved portions of the theatrical scripts are then distributed in text mode which appears in each user's wearable displays 25A, 25B.

In another embodiment of the invention, the theatrical moderating program 140A, 140B may be distributed between the portable theatrical units 110A, 110B. For example, the entire theatrical script 30 may be sent to the portable theatrical units 110A, 110B and each portable theatrical unit 110A, 110B may perform the determination as to which lines to display to its associated user 101A, 101B. In this embodiment of the invention, coordination and synchronization of theatrical lines, cues and stage directions are provided in a peer-to-peer arrangement. In this example, the portable theatrical units 110A, 110B, communicate directly with each other 105C eliminating the need for a separate theatrical moderating computer 100.

In another example, signals may be exchanged between the portable theatrical units 110A, 110B indicating which lines of the theatrical script are currently being displayed to each associated user 101A, 101B; which lines of theatrical script a user 101A, 101B, has just recited as determined by speech recognition 80P or VOX 50P, or which line of theatrical script a user 101A, 101B, has just finished reciting as indicated by the user input such as a button press 60A, 60B.

In a final embodiment of the invention, one of the portable theatrical units 110A, 110B assumes the role of the theatrical moderating computer 100 and controls the remaining portable theatrical unit(s) 110A, 110B.

Referring to FIG. 2A, a virtually shared space embodiment of the invention is depicted. This embodiment of the invention is directed toward a virtual performance area 200V. In the virtual embodiments of the invention, the users are not physically co-located within the performance area but are remotely located and enact the theatrical performance through simulated avatars within the virtual performance area 200V. In this virtual embodiment of the invention, the theatrical moderating computer 100 maintains a master theatrical script in a datastore M 30. The theatrical moderating computer 100 distributes each remote user's portion of the theatrical script over a network 205 based on a unique identifier (e.g., IP address, username, etc.) which identifies each remote user's computers

In addition, the client portions of the theatrical moderating program 140A, 140B may be downloaded and/or updated as well from the theatrical moderating computer 100. In this exemplary embodiment of the invention, the theatrical moderating computer 100 assigns an avatar 210A, 210B, 210C to each remote user 101A, 101B.

Alternately, each user 101A, 101B may select the avatar role desired and any remaining roles called for by the theatrical script are performed by the theatrical moderating computer 100. In this example, the theatrical script requires three users. Two avatars 210A, 210B are controlled by the users 101A, 101B, and the remaining avatar 210C is therefore controlled automatically by the theatrical moderating computer 100. Each virtual player 101A, 101B generally shares the same view 25n, although perspective differences based on location or an avatar's activity or scripted situation may provide differing perspectives to each of the users 101A, 101B.

The users 101A, 101B may communicate with each other and the theatrical moderating computer 100 using the headsets 95A1, 95A2, 95B1, 95B2 described previously. In addition, three dimensional theatrical performances may be accomplished using the wearable displays 25A1, 25A2.

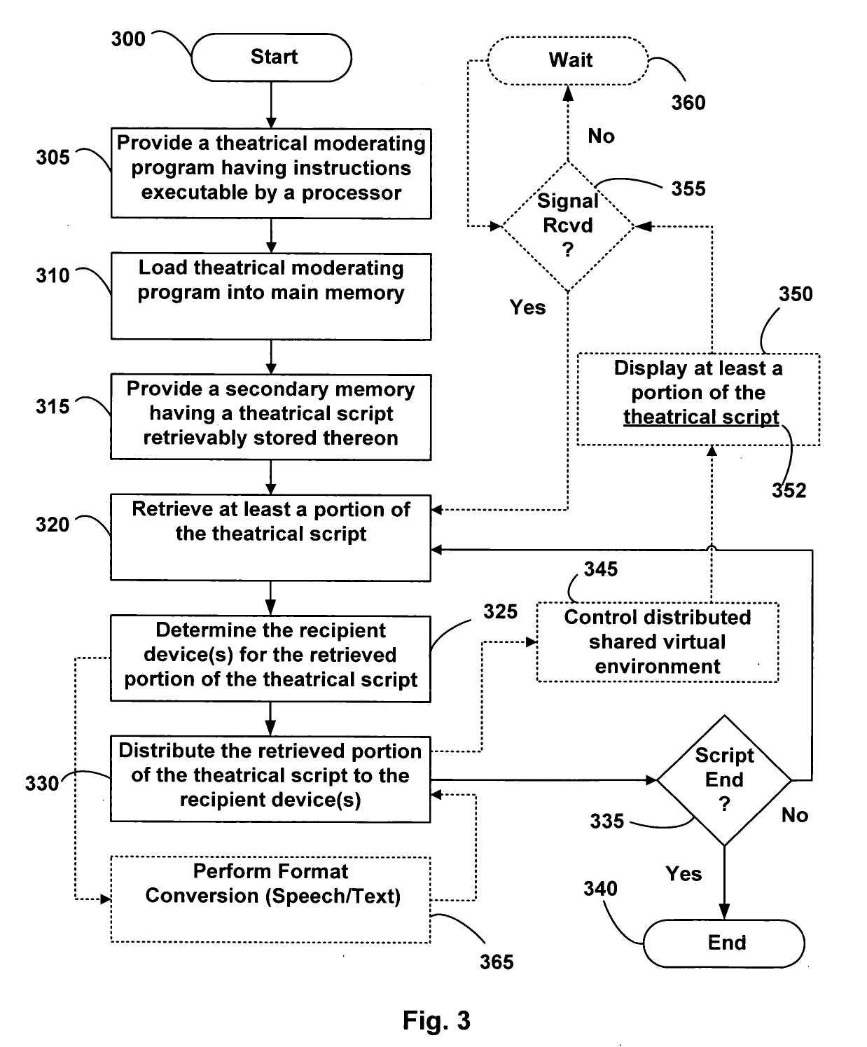

Referring to FIG. 3, a process flow chart is provided for implementing an exemplary embodiment of the invention. In this embodiment, the process is initiated 300 by providing a theatrical moderating program 140 having instructions executable by a processor 305 associated with either a theatrical moderating computer 100 and/or a portable theatrical unit 110 described above.

The theatrical moderating program 140 is loaded into the main memory 310 of a theatrical moderating computer 100 and/or portable theatrical unit 110 and executed. A theatrical script is then retrievably provided in a secondary memory accessible by the processor 315. The theatrical moderating program 140 retrieves at least a portion of the theatrical script from the secondary memory 320, the portion of the theatrical script includes a plurality of theatrical lines, each of the theatrical lines being associated with one or more theatrical characters contained within the theatrical script.

The theatrical moderating program 140 then determines which recipient device(s) will receive their applicable theatrical lines of the theatrical script 325 based upon the character(s) associated with each of the theatrical lines and the characters associated with each recipient device. The theatrical moderating program 140 then distributes the retrieved portion(s) of the theatrical script(s) to each applicable recipient device 330.

If the end of the theatrical script 335 has been reached, the process ends 340. If additional theatrical lines need to be distributed to the recipient devices 335, the theatrical moderating program 140 retrieves another portion of the theatrical script from the secondary memory 320 and again determines which recipient devices receive their applicable theatrical lines of the theatrical script 325.

The theatrical moderating program 140 then again distributes the retrieved portion(s) of the theatrical script(s) to each recipient device 330 until the end of the theatrical script 335 is finally reached, causing the process to end 340. In a related embodiment of the invention, a text to speech conversion is made 365 in which the text of the theatrical script is converted to an aural form and is sent to the appropriate recipient device(s) to allow a user to aurally monitor the theatrical script. In another related embodiment of the invention, the theatrical moderating program 140 controls the distributed virtually shared space 345 for each of the users 101A, 101B as described above. In yet another embodiment of the invention, at least a portion of the theatrical script (theatrical lines) 350 is displayed on one or more of the recipient devices, usually a portable theatrical device 110. The displayed theatrical script may be visually enhanced or graphically accentuated 352 to improve readability or to cue the user(s) 101A, 101B to begin his or her performance(s).

In a final embodiment of the invention, the theatrical moderating program 140 waits 360 for a signal or cue 355 to be received from one or more of the recipient devices 110 or theatrical moderating computer 100 before retrieving another portion of the theatrical script 320 and/or before distributing lines of the theatrical script and/or before triggering cues for users to perform particular theatrical lines of the theatrical script.

If no signal is received, 355 the theatrical moderating program 140 is placed in a temporary wait state 360. If a signal is received, 355 the theatrical moderating program 140 retrieves another portion of the theatrical script 320 and the process continues.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. Other variations and embodiments are possible in light of above teachings, and it is not intended that this Detailed Description limit the scope of invention, but rather by the Claims following herein.

What is claimed:

1. A distributed theatrical moderating system comprising:
a first computer in processing communications with at least one recipient device, said first computer including;
a theatrical moderating program operatively loaded into a main memory of said first computer; said theatrical moderating program including instructions executable by a processor associated with said first computer to;
retrieve at least a portion of a theatrical script from a secondary memory operatively coupled to at least said first computer; wherein at least a portion of said retrieved portion of said theatrical script is associated with at least one theatrical character;
determine said at least one recipient device in at least partial dependence on a preexisting relationship between said at least one recipient device and said at least one theatrical character; and,
distribute at least a portion of said retrieved portion of said theatrical script to said at least one recipient device in a predetermined sequence.

2. The system according to claim 1 wherein said at least one recipient device is at least a second computer in processing communications with said first computer.

3. The system according to claim 2 wherein said first computer and at least said second computer share a virtually shared space in which at least one avatar exists.

4. The system according to claim 1 wherein said at least one recipient device is a portable theatrical unit associated with a user existing in a physically shared space.

5. The system according to claim 1 wherein said theatrical moderating program further includes instructions executable by said processor to distribute an additional portion of said theatrical script to said at least one recipient device in at least partial dependence upon receipt of a signal sent from said at least one recipient device.

6. The system according to claim 4 wherein said portable theatrical unit includes a user interface functional to communicate at least a portion of said distributed portion of said theatrical script to said user.

7. The system according to claim 4 wherein said processing communication includes a wireless communications link between at least said first computer and said portable theatrical unit.

8. The system according to claim 6 wherein said user interface includes one of a wearable display, an earphone, a microphone, a switch, a button, a knob and any combination thereof.

9. The system according to claim 4 wherein said portable theatrical unit is one of, a personal digital assistant, a cellular telephone, a wireless headset, a wearable display, a wearable computer, a wireless peripheral device operatively coupled to said first computer and any combination thereof.

10. The system according to claim 5 wherein said portable theatrical unit further includes a VOX circuit functional to send said signal to at least said first computer when said user has at least stopped speaking.

11. The system according to claim 5 wherein said portable theatrical unit further includes a motion sensor circuit functional to send said signal to said first computer when said user has at least stopped moving.

12. The system according to claim 5 wherein said portable theatrical unit further includes a peripheral state sensing circuit functional to send said signal to at least said first computer when said user has interacted with a peripheral device operatively coupled to said peripheral state sensing circuit functional.

13. The system according to claim 5 wherein said portable theatrical unit includes a speech recognition program functional to generate said signal when said user has at least completed reciting a contemporaneous portion of said distributed theatrical script.

14. The system according to claim 3 wherein a user controls at least a motion associated with said avatar from said second computer system.

15. The system according to claim 3 wherein said first computer controls at least a motion associated with said avatar based at least in part upon said theatrical script.

16. The system according to claim 1 wherein said distributed portion of said theatrical script includes at least a dialog to be recited by a user associated with said at least one recipient device.

17. The system according to claim 1 wherein said theatrical moderating program further includes instructions executable by said processor to perform text to speech conversion on at least a portion of text retrieved from said theatrical script.

18. The system according to claim 17 wherein said text to speech conversion is performed before said retrieved portion of said theatrical script is distributed to said at least one recipient device.

19. The system according to claim 1 wherein said at least a portion of said retrieved portion of said theatrical script includes at least one theatrical line associated with said at least one theatrical character.

20. The system according to claim 1 wherein said at least one theatrical character is assigned to a user by said first computer.

21. The system according to claim 1 wherein said at least one theatrical character is selected by a user in at least partial dependence on an input provided by said user.

22. The system according to claim 1 wherein said theatrical script includes a plurality of theatrical lines that are each associated with said at least one theatrical character; and wherein said theatrical moderating program distributes each of said plurality of theatrical lines to said at least one recipient device in a predetermined sequence; and wherein said predetermined sequence being at least partially dependent upon a content of said theatrical script.

23. A distributed method of theatrical moderating comprising:
providing a theatrical moderating program operatively loadable into a main memory of a first computer and executable by a processor associated with said first computer;
providing in a secondary memory associated with at least said first computer a retrievable theatrical script; wherein at least a portion of said theatrical script is associated with at least one theatrical character;
providing said theatrical moderating program instructions executable by said processor to retrieve at least a portion of said theatrical script;
providing said theatrical moderating program instructions executable by said processor to determine at least one recipient device in at least partial dependence on a preexisting relationship between said at least one recipient device and said at least one theatrical character; and,
providing said theatrical moderating program instructions executable by said processor to distribute at least a portion of said retrieved portion of said theatrical script to said at least one recipient device.

24. The method according to claim 23 further providing said theatrical moderating program with instructions executable by said processor to distribute an additional portion of said theatrical script to said at least one recipient device in dependence on receipt of a signal sent from said at least one recipient device.

25. The method according to claim 23 further providing said theatrical moderating program with instructions executable by said processor to perform text to speech conversion on at least a portion of text retrieved from said theatrical script

26. The method according to claim 23 further providing said theatrical moderating program with instructions executable by said processor to control a distributed virtually shared space.

27. A computer program product embodied in a tangible form comprising instructions executable by a processor to;
retrieve at least a portion of a theatrical script from a secondary memory operatively coupled to at least a first computer; wherein at least a portion of said theatrical script is associated with at least one theatrical character;
determine at least one recipient device in at least partial dependence on a definable relationship between said at least one recipient device and said at least one theatrical character; and,
distribute at least a portion of said retrieved portion of said theatrical script to said at least one recipient device in a predetermined sequence.

28. The computer program product according to claim 27 wherein said tangible form comprises magnetic media, optical media or logical media.

29. The computer program product according to claim 27 further including instructions executable by said processor to provide a signal to said at least one recipient device to responsibly display a cue, wherein said cue is one of, a visual and an aural cue.

30. A computer moderated method of coordinating a plurality of users engaged in a shared theatrical experience comprising:
providing an intelligent display device to each of said plurality of users;
each of said intelligent display devices including a processor, a memory coupled to said processor, and a display coupled to said processor to said processor;
providing a theatrical script loadable into said memory of each of said intelligent display devices, wherein said theatrical script includes a plurality of theatrical lines, each of said plurality of theatrical lines having an association with at least one of a plurality of available theatrical characters;
providing a theatrical moderating program loadable into the memory of each of said intelligent display devices including instructions executable by each of said processors to;
implement an assignment of said intelligent display device with said at least one of said plurality of available theatrical characters;
access from said memory, a theatrical line of said plurality of theatrical lines having said association; and,
display at least a portion of said accessed theatrical line to a user of said plurality of users in at least partial dependence upon a correlation between said association and said assignment.

31. The method according to claim 30 wherein said display of said accessed theatrical line is provided to said user in at least partial dependence on a predetermined sequence of theatrical lines defined by said theatrical script.

32. The method according to claim 30 wherein said display of said accessed theatrical line is provided to said user in at least partial dependence on a signal sent from at least a second intelligent display device.

33. The method according to claim 30 wherein said intelligent display device is embodied in a container dimensioned to be worn or carried by said user.

34. The method according to claim 30 wherein said intelligent display device is a computer programmed to display a virtual shared space in which at least a plurality of avatars exist, each of said avatars representing a theatrical character of said shared theatrical experience.

35. The method according to claim 30 wherein said display of said accessed theatrical line is provided in a visual text format.

36. The method according to claim 35 wherein said display of said accessed theatrical line is provided in an audio format.

37. The method according to claim 30 wherein said at least one theatrical character is determinable by an input provided by said user of said intelligent display device.

38. The method according to claim 30 wherein each of said intelligent display devices is associated with a different theatrical character of said shared theatrical experience.
